(19) United States
(12) Patent Application Publication
(10) Pub. No.: US 2010/0026502 A1
(43) Pub. Date: Feb. 4, 2010

(54) APPARATUS AND METHOD FOR AUTOMATICALLY SELECTING AND EXECUTING FILES ASSOCIATED WITH ENVIRONMENT

(75) Inventor: MIN YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/237,677

(22) Filed: Sep. 25, 2008

(30) Foreign Application Priority Data
Jul. 31, 2008 (CN) 200810303288.4

(51) Int. Cl. G08B 21/00; G08B 17/00

(52) U.S. Cl. 340/584; 340/540

(57) ABSTRACT

An apparatus for automatically selecting and executing files associated with the environment includes a detecting module, an analysis module, and a system module. The detecting module detects environmental parameters and transmits the environmental parameters to the analysis module. The analysis module detects a present status of the apparatus, compares the environmental parameters detected by the detecting module to a plurality of predetermined parameters stored in the analysis module, and outputs control signals according to the comparison and the present status of the apparatus. The system module receives the control signals and adjusts parameters of the apparatus according to the control signals.

### BACKGROUND

1. Technical Field

The present invention relates to an apparatus and method for automatically selecting and executing files associated with environment.

2. Description of Related Art

A typical digital photo frame is capable of storing many different files, such as photos and music, and are able to randomly display these files in a predetermined manner. For example, users are able to select particular groups of images to view and music to hear based on the current room temperature. However, finding and selecting the desired files is complicated and inconvenient.

Therefore, an apparatus and method for selecting and executing files is desired to overcome the above-described shortcomings.

### BRIEF DESCRIPTION OF THE DRAWINGS

FIG. 1 is a block diagram of an embodiment of an apparatus for automatically selecting and executing files associated with the environment; and

FIG. 2 is a flow chart of an embodiment of a method for automatically selecting and executing files associated with the environment.

### DETAILED DESCRIPTION OF THE EMBODIMENTS

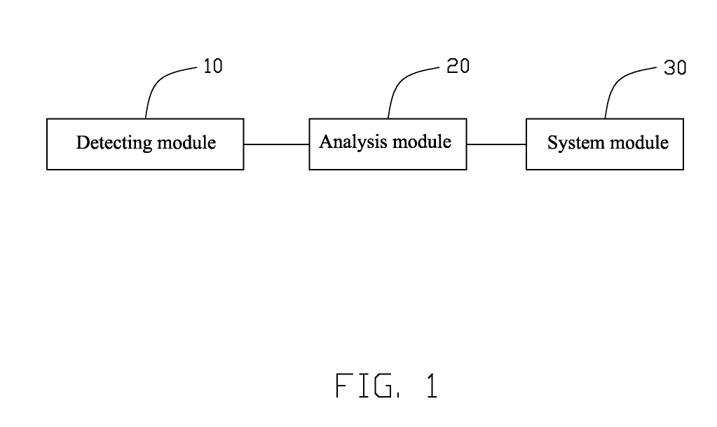

Referring to FIG. 1, an embodiment of an apparatus for automatically selecting and executing files associated with the environment includes a detecting module 10, an analysis module 20, and a system module 30.

In one embodiment, the apparatus is a digital photo frame. The detecting module 10 is configured to detect environmental parameters and transmit the environmental parameters to the analysis module 20. The analysis module 20 is configured to detect a present status of the digital photo frame, compare the environmental parameters detected by the detecting module 10 to a plurality of predetermined parameters stored in the analysis module 20, output control signals according to the comparison and the present status of the digital photo frame. The system module 30 is configured to receive the control signals, and adjust parameters of the digital photo frame according to the control signals.

The detecting module 10 includes a temperature detecting module (not labeled) configured to detect temperature, a light detecting module (not labeled) configured to detect light, and a volume detecting module (not labeled) configured to detect noise of the environment. The analysis module 20 stores a plurality of predetermined temperature, luminance, and volume values. The system module 30 includes an image managing module (not labeled), a music managing module (not labeled), a luminance managing module (not labeled), and a volume managing module (not labeled). In this embodiment, the analysis module 20 stores a lower limit value of temperature T1, an upper limit value of temperature T2, a lower limit value of luminance L1, an upper limit value of luminance L2, a lower value limit of volume V1, and an upper limit value of volume V2.

The temperature T, luminance L, and volume V of the environment are detected by the detecting module. If T<T1, the analysis module 20 outputs a control signal of low temperature to the image managing module and music managing module of the system module 30. Subsequently, the digital photo frame proceeds to display images and music configured for low-temperature environments. If T>T2, the analysis module 20 outputs a control signal of high temperature to the image managing module and music managing module of the system module 30. Subsequently, the digital photo frame proceeds to display images and music configured for high-temperature environments. If L<L1, the analysis module 20 outputs a control signal of dark luminance to the luminance managing module of the system module 30. Subsequently, the digital photo frame increases the display luminance of the images. If L>L2, the analysis module 20 outputs a control signal of bright luminance to the luminance managing module of the system module 30. Subsequently, the digital photo frame decreases the display luminance of the images. If V<V1, the analysis module 20 outputs a control signal of low noise to the volume managing module of the system module 30. Subsequently, the digital photo frame decreases the volume of the apparatus. If V>V2, the analysis module 20 outputs a control signal of high noise to the volume managing module of the system module 30. Subsequently, the digital photo frame increases the volume of the apparatus. If the temperature, luminance, and volume of the environment are between the corresponding lower limit and upper limit values, the digital photo frame display images and music configured for normal temperature environments.

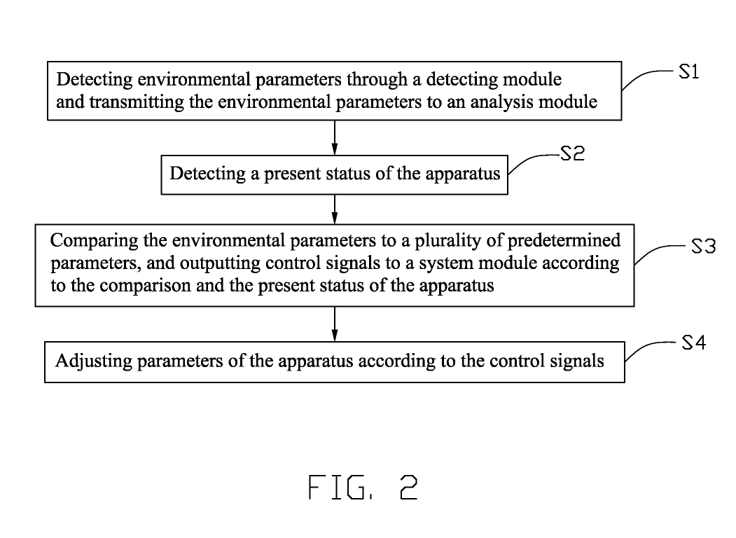

Referring to FIG. 2, a flowchart illustrates an embodiment of a method for automatically selecting and executing files associated with the environment. Depending on the embodiment, some of the steps described below may be removed, while others may be added, and the sequence of steps may be altered as well.

In a step S1, the detecting module 10 detects environmental parameters, and transmits the environmental parameters to the analysis module 20.

Continuing to a step S2, the analysis module 20 detects a present status of the digital photo frame.

Moving to a step S3, the analysis module 20 compares the environmental parameters to the predetermined parameters stored in the analysis module 20, and outputs control signals to the system module according to the comparison and the present status of the digital photo frame.

If the environmental parameter for temperature is lower than the corresponding lower limit value, the analysis module 20 outputs a control signal of low temperature to the image managing module and music managing module. If the environmental parameter for temperature is higher than the corresponding upper limit value, the analysis module 20 outputs a control signal of high temperature to the image managing module and music managing module. If the environmental parameter for temperature is between the corresponding lower limit and upper limit values, the analysis module 20 outputs a control signal of normal temperature to the image managing module and music managing module. If the present status of the apparatus corresponds to the environmental parameter for temperature, the analysis module 20 does not output a control signal and the digital photo frame maintains its present status.

If the environmental parameter for luminance and volume are lower than the corresponding lower limit values, the analysis module 20 outputs a control signal of dark luminance to the luminance managing module, and a control signal of low noise to the volume managing module. If the environmental parameters for luminance and volume are greater than the corresponding upper limit values, the analysis module 20 outputs a control signal of bright luminance to the luminance managing module, and a control signal of high noise to the volume managing module. If the environmental parameters for luminance and volume are between the corresponding lower limit and upper limit values, the analysis module 20 outputs a control signal of normal luminance to the luminance managing module, and a control signal of normal noise to the volume managing module. If the present status of the apparatus corresponds to the environmental parameter for luminance and volume, the analysis module 20 does not output a control signal and the digital photo frame maintains its present status.

Continuing to a step S4, the system module 30 adjusts parameters of the digital photo frame according to the control signals.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. An apparatus comprising:
a detecting module configured to detect environmental parameters;
an analysis module configured to detect a present status of the apparatus, compare the environmental parameters detected by the detecting module to a plurality of predetermined parameters stored in the analysis module, and output control signals according to the comparison and the present status of the apparatus; and
a system module configured to receive the control signals and adjust current parameters of the apparatus according to the control signals.

2. The apparatus of claim 1, wherein the detecting module comprises a temperature detecting module configured to detect a temperature of the environment, a light detecting module configured to detect a luminance of the environment, and a volume detecting module configured to detect a volume of the environment.

3. The apparatus of claim 2, wherein the system module comprises an image managing module configured to adjust images of the apparatus, a music managing module configured to adjust music of the apparatus, a luminance managing module configured to adjust luminance of the apparatus, and a volume managing module configured to adjust volume of the apparatus.

4. The apparatus of claim 3, wherein the predetermined parameters comprise a plurality of predetermined temperature values, a plurality of predetermined luminance values, and a plurality of predetermined volume values.

5. A method for automatically selecting and executing files associated with an environment of an apparatus, the method comprising:
detecting environmental parameters through a detecting module and transmitting the environmental parameters to an analysis module;
detecting a present status of the apparatus;
comparing the environmental parameters to a plurality of predetermined parameters, and outputting control signals to a system module according to the comparison and the present status of the apparatus; and
adjusting parameters of the apparatus according to the control signals.

6. The method of claim 5, wherein the predetermined parameters comprise a plurality of lower limit values and upper limit values of temperature, luminance, and volume.

7. The method of claim 6, wherein the system module comprises an image managing module configured to adjust images of the apparatus, a music managing module configured to adjust music of the apparatus, a luminance managing module configured to adjust luminance of the apparatus, and a volume managing module configured to adjust volume of the apparatus.

8. The method of claim 7, wherein the analysis module does not output the control signals if the present status of the apparatus corresponds to the environmental parameters.

9. The method of claim 7, wherein if an environmental parameter for temperature is lower than a corresponding lower limit value, the analysis module outputs a control signal of low temperature to the image managing module and music managing module.

10. The method of claim 7, wherein if an environmental parameter for temperature is higher than a corresponding upper limit value, the analysis module outputs a control signal of high temperature to the image managing module and music managing module.

11. The method of claim 7, wherein if an environmental parameter for temperature is between corresponding lower limit and upper limit values, the analysis module outputs a control signal of normal temperature to the image managing module and music managing module.

12. The method of claim 7, wherein if environmental parameters for luminance and volume are lower than corresponding lower limit values, the analysis module outputs a control signal of dark luminance to the luminance managing module, and a control signal of low noise to the volume managing module.

13. The method of claim 7, wherein if environmental parameters for luminance and volume are greater than corresponding upper limit values, the analysis module outputs a control signal of bright luminance to the luminance managing module, and a control signal of high noise to the volume managing module.

14. The method of claim 7, wherein if environmental parameters for luminance and volume are between corresponding lower limit and upper limit values, the analysis module outputs a control signal of normal luminance to the luminance managing module, and a control signal of normal noise to the volume managing module.
